(19) United States
(12) Patent Application Publication
(10) Pub. No.: US 2002/0112803 A1
(43) Pub. Date: Aug. 22, 2002

(54) Vehicle tire breaker and anti-knock arrangement

(76) Inventor: Shut Chen Hsu, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,130

(22) Filed: Oct. 23, 2001

Related U.S. Application Data
(63) Continuation-in-part of application No. 09/789,169, filed on Feb. 20, 2001.

(51) Int. Cl. B60C 9/00

(52) U.S. Cl. 152/531; 361/728; 152/532

(57) ABSTRACT

A vehicle tire breaker and anti-knock arrangement includes an outer tire, the outer tire having an intermediate layer of breaker of woven fabrics and mounting holes in two inward lips thereof, and a reinforcing bearing loop supported inside the outer tire and secured thereto by inserting respective pins of the reinforcing bearing loop into respective mounting holes in inward lips of the outer tire, the reinforcing bearing loop being formed of a plurality of reinforcing bearing devices connected in series by pivot pins and adapted to support the tire for enabling the vehicle to keep running when the tire leaks.

### CROSS-REFERENCE TO RELATED APPLICATION

The present invention relates to in a continuation-in-part of application Ser. No. 09/789,169, entitled “VEHICLE TIRE WITH TIRE BREAKER AND ANTI-KNOCK ARRANGEMENT”.

### BACKGROUND OF THE INVENTION

The present invention provides a vehicle tire breaker and anti-knock arrangement, which improves the design of application Ser. No. 09/789,169.

The vehicle tire with tire breaker and anti-knock arrangement according to application Ser. No. 09/789,169 teaches the use of an annular tire support structure in the outer tire so that the vehicle can keep running upon an air leakage. This design is functional, however, it is complicated to mount or dismount the annular tire support structure

### SUMMARY OF THE INVENTION

The present invention has been accomplished under the circumstances in view. It is the main object of the present invention to provide a vehicle tire breaker and anti-knock arrangement, which eliminates the aforesaid problems. According to one aspect of the present invention, the vehicle tire breaker and anti-knock arrangement comprises an outer tire, the outer tire having an intermediate layer of breaker of woven fabrics and mounting holes in two inward lips thereof, and a reinforcing bearing loop supported inside the outer tire, the reinforcing bearing loop being formed of a plurality of reinforcing bearing devices connected in series and adapted to support the tire for enabling the vehicle to keep running when the tire leaks. According to another aspect of the present invention, each reinforcing bearing device is comprised of a smoothly arched bottom plate having a bottom sidewall and a top sidewall, a flexible bottom pad fixedly fastened to the bottom sidewall of the bottom plate, a plurality of longitudinal ribs fixedly provided at the top sidewall of the bottom plate, a plurality of transverse mounting devices fixedly fastened to the top sidewall of the bottom plate and extended across the longitudinal ribs for securing to the inward lips of the outer tire, two rows of barrels respectively transversely aligned at two ends of the bottom plate for enabling the reinforcing bearing devices to be connected to one another by pivot pins, and a flexible top bar longitudinally supported on the transverse mounting devices.

### BRIEF DESCRIPTION OF THE DRAWINGS

FIG. 1 is a sectional elevation of a vehicle outer tire according to the present invention.

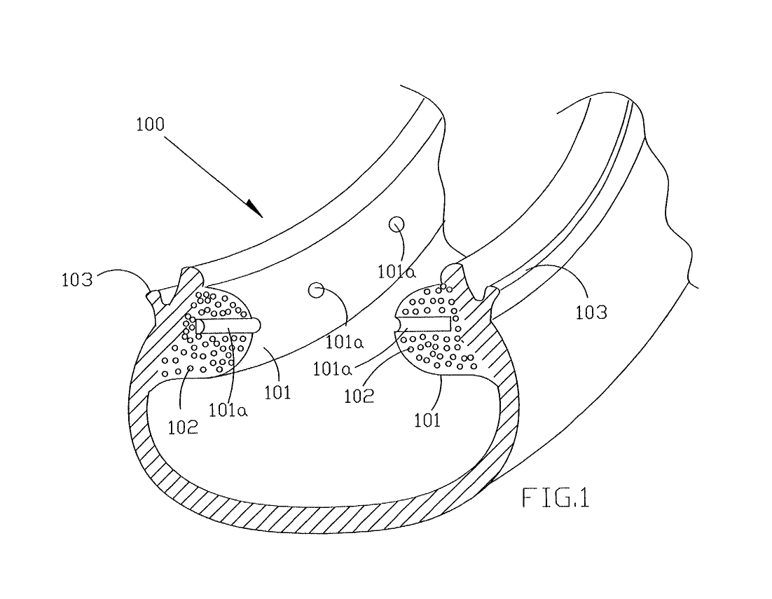

FIG. 2 is a perspective view of a transverse mounting device according to the present invention.

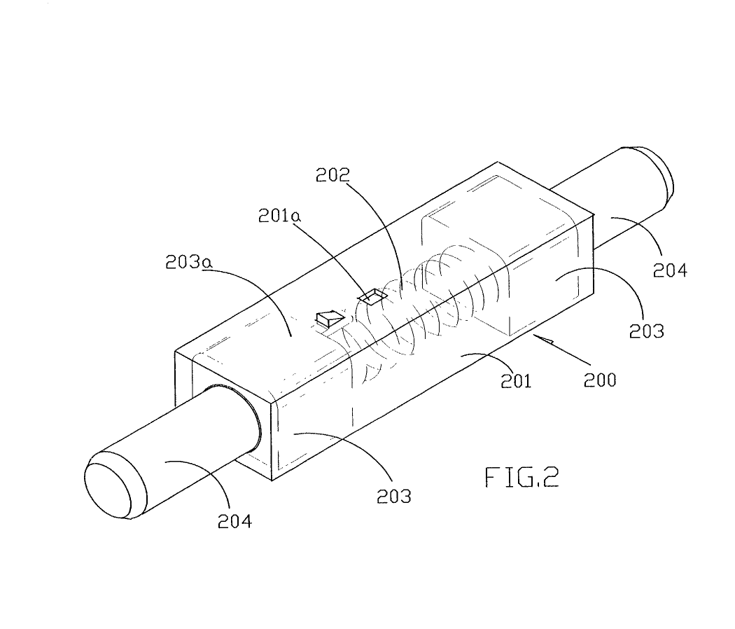

FIG. 3 is an elevational view of the transverse mounting device showing the pin moved with the respective sliding block backwards to the inside of the casing.

FIG. 4 is a perspective view of a reinforcing bearing device according to the present invention.

FIG. 5 is a side view of a reinforcing bearing loop according to the present invention.

FIG. 6 is a sectional view of the present invention, showing the reinforcing bearing loop installed in the outer tire fastened to the wheel rim.

FIG. 7 is a sectional view of an alternate form of the present invention.

### DETAILED DESCRIPTION OF THE PREFERRED EMBODIMENT

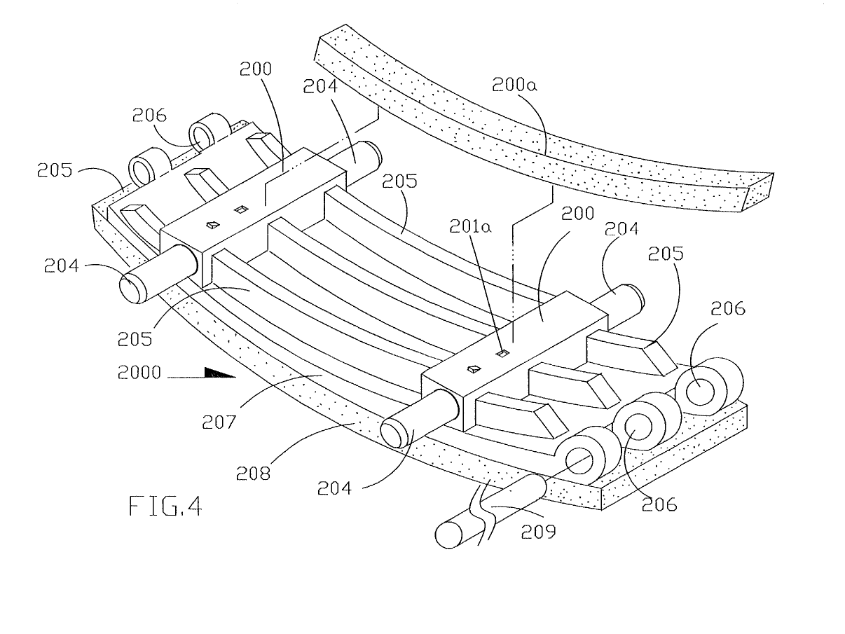

Referring to FIGS. from 1 through 6, the outer tire 100 (see FIG. 4) comprises two inward lips 101 and two outward lips 103 respectively bilaterally extended along two ends thereof, a plurality of steel ropes 102 embedded in the inward lips 101 to reinforce the structure, and two rows of mounting holes 101a respectively arranged on the inward lips 101.

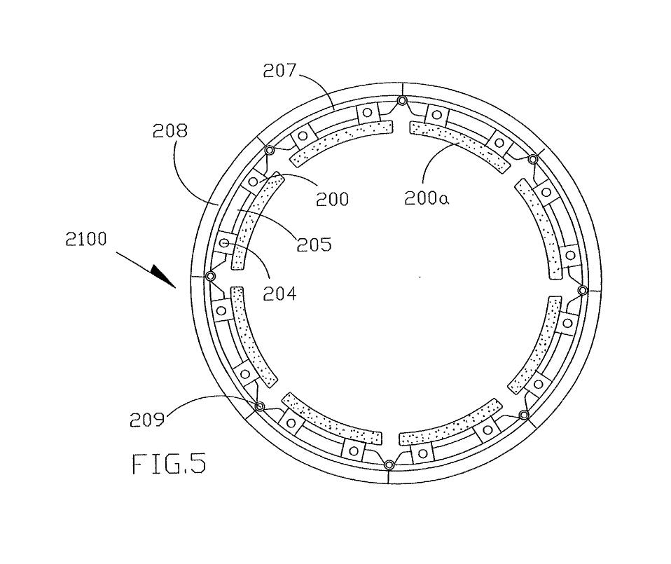

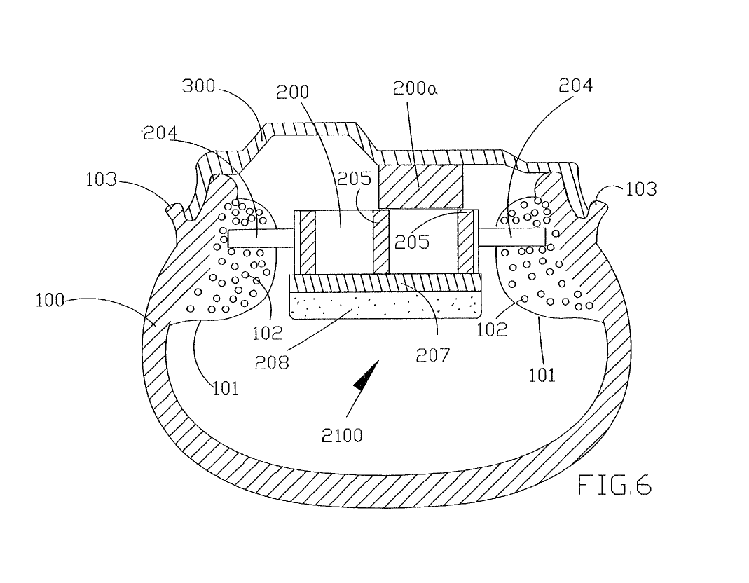

A plurality of reinforcing bearing devices 2000 are connected in series and fastened to the outer tire 100 between the inward lips 101 (see FIGS. from 4 through 6). Each reinforcing bearing device 2000 is comprised of a smoothly arched bottom plate 207, a flexible bottom pad 208 fixedly fastened to the bottom sidewall of the bottom plate 207, a plurality of longitudinal ribs 205 fixedly provided at the top sidewall of the bottom plate 207, a plurality of transverse mounting devices 200 fixedly fastened to the top sidewall of the bottom plate 207 and extended across the longitudinal ribs 205, two rows of barrels 206 respectively transversely aligned at two ends of the bottom plate 207, and a flexible top bar 200a longitudinally supported on the transverse mounting devices 200. Each transverse mounting device 200 comprises a casing 201, the casing 201 having a plurality of retaining holes 201a, two sliding blocks 203 mounted inside the casing 201 and can be moved relative to each other, a spring 202 mounted inside the casing 201 and stopped between the sliding blocks 203 and adapted to force the sliding blocks 203 outwards toward the two ends of the casing 201. The sliding blocks 203 each have a hook 203a for hooking in one of the retaining holes 201a, and a pin 204 extended out of the casing 203 through a respective end hole (not shown) of the casing 201. Pivot pins 209 are respectively inserted into the barrels 206 to connect the reinforcing bearing devices 2000 into a reinforcing bearing loop 2100 (see FIGS. 5 and 6).

Referring to FIG. 6, during installation, the reinforcing bearing loop 2100 is mounted in the outer tire 100, and the pins 204 of the transverse mounting devices 200 are respectively plugged into the mounting holes 101a of the inward lips 101, and then the outer tire 100 is installed in the wheel rim 300.

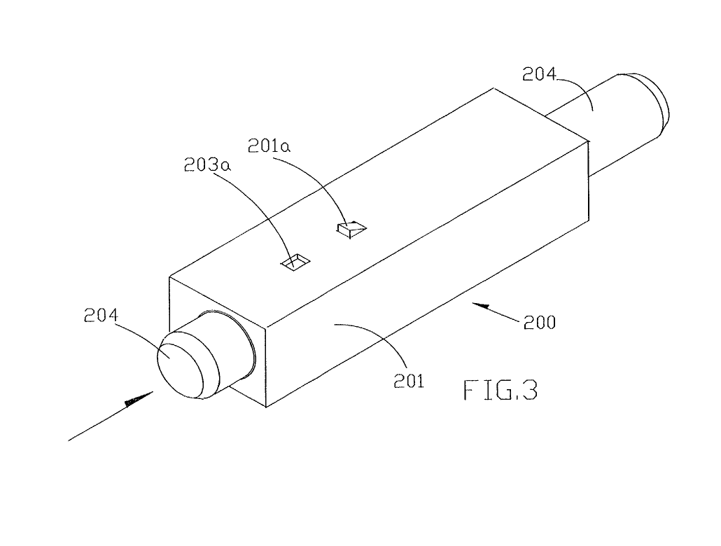

In case a pointed external object pierced the outer tire 100 (see FIG. 3), the breaker 22 blocks the pointed external object from passing to the inside, and the reinforcing bearing loop 2100 supports the vehicle tire, enabling the vehicle tire to keep running.

When repairing the tire, the wheel rim 300 is removed from the outer tire 100, and then a tool is used to disengage the hooks 203a of the sliding blocks 203 from the respective retaining holes 201a, enabling the pins 294 to be respectively moved backwards and disengaged from the respective mounting holes 101a of the inward lips 101, and then the reinforcing bearing loop 2100 is removed from the outer tire 100.

When the tire leaks, the reinforcing bearing loop 2100 supports the vehicle tire, enabling the vehicle to keep running, and at this time the outer lips 103 of the outer tire 100 protect the wheel rim 300, preventing separation of the outer tire 100 from the wheel rim 300.

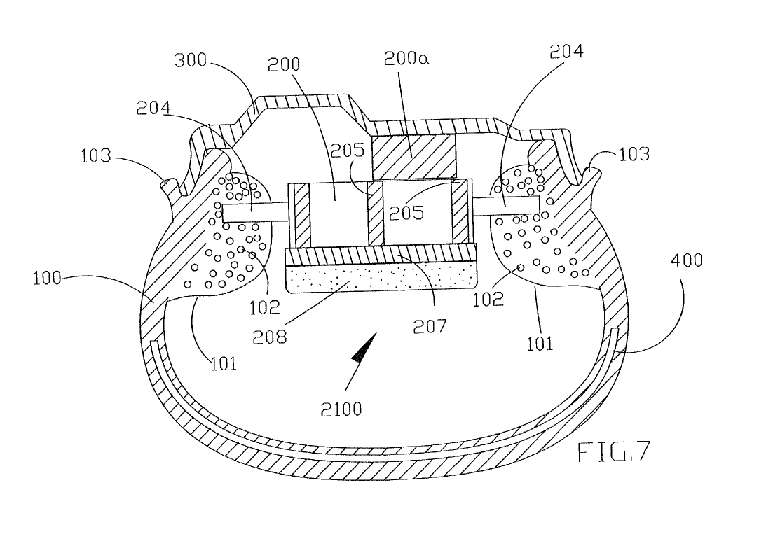

FIG. 7 shows an alternate form of the present invention. According to this alternate form, the outer tire 100 has a reinforcing woven fabric 400 embedded therein.

It is to be understood that the drawings are designed for purposes of illustration only, and are not intended for use as a definition of the limits and scope of the invention disclosed.

What the invention claimed is:

1. A vehicle tire breaker and anti-knock arrangement comprising:
an outer tire, said outer tire comprising an intermediate layer of breaker formed of woven fabric of flexible strings, two inward lips respectively extended along two ends thereof, a plurality of steel ropes embedded in said inward lips to reinforce the structure, and two rows of mounting holes respectively arranged on said inward lips; and
a reinforcing bearing loop supported inside said outer tire, said reinforcing bearing loop comprising a plurality of reinforcing bearing devices connected in series and fastened to said outer tire between said inward lips, said reinforcing bearing devices each comprised of a smoothly arched bottom plate having a bottom sidewall and a top sidewall, a flexible bottom pad fixedly fastened to the bottom sidewall of said bottom plate, a plurality of longitudinal ribs fixedly provided at the top sidewall of said bottom plate, a plurality of transverse mounting devices fixedly fastened to the top sidewall of said bottom plate and extended across said longitudinal ribs, two rows of barrels respectively transversely aligned at two ends of said bottom plate, and a flexible top bar longitudinally supported on the transverse mounting devices, the barrels at one end of the bottom plate of one of said reinforcing bearing devices being connected to the barrels at one end of the bottom plate of another of said reinforcing bearing devices by a pivot pin, said transverse mounting devices each comprising a casing, said casing having a plurality of retaining holes, two sliding blocks mounted inside said casing, a spring stopped between said sliding blocks inside said casing and adapted to force said sliding blocks outwards toward two distal ends of said casing, said sliding blocks each having a hook adapted to engage one of said retaining holes of said casing and a pin extended out of said casing through a respective end hole of said casing and adapted to engage one of the mounting holes of the inward lips of said outer tire.

2. The vehicle tire breaker and anti-knock arrangement as claimed in claim 1 wherein said outer tire further comprises two outward lips adapted to cover a part of the wheel rim in which the vehicle tire is to be installed.
